(19) United States
(12) Patent Application Publication
(10) Pub. No.: US 2012/0159823 A1
(43) Pub. Date: Jun. 28, 2012

(54) APPARATUS AND METHOD TO HOUSE CABLE TENSIONING SYSTEM

(75) Inventors: John Dove Gibb, Buford, GA (US); Thomas Stover, Braselton, GA (US); Christopher Jonathan Adams, Hoschton, GA (US)

(73) Assignee: Formetco, Inc., Duluth, GA (US)

(21) Appl. No.: 13/019,910

(22) Filed: Feb. 2, 2011

Related U.S. Application Data
(63) Continuation-in-part of application No. 12/978,163, filed on Dec. 23, 2010.

(51) Int. Cl. G09F 15/00

(52) U.S. Cl. 40/606.01

(57) ABSTRACT

A trim base C-shaped channel having a front face, a bottom face, and a hanger face configured to form a trough or C-channel; one or more T-tracks and splice tracks positioned on the interior of the trough or C-channel for mounting a plurality of components of a cable tensioning system; a concave member positioned on the front face; a trim cap having a support extension and a contact extension configured to rotate about the concave member, wherein the trim cap is configured to cover the trough or open top of the C-channel; and a spring positioned between one hanger section and the support extension, wherein the spring is configured to rotate the trim cap about the concave member and, thus, functions to conceal the cable, pulleys, guides, and other individual components of a billboard cable tensioning system used to secure and stretch a printed display sheet.

### PRIORITY CLAIM TO RELATED US APPLICATIONS

To the full extent permitted by law, the present U.S. Non-provisional patent application, is a Continuation-in-Part of, and hereby claims priority to and the full benefit of U.S. Non-provisional application entitled “Border Trim Assembly and Method of use for a Wood-framed Billboard with a Cable Tensioning System,” having assigned Ser. No. 12/978,163, filed on Dec. 23, 2010, incorporated herein by reference in its entirety.

### TECHNICAL FIELD

The disclosure relates generally to border trim on a billboard and more specifically it relates to an apparatus and method using aluminum extrusions to form the trim or border of a billboard or sign to house the cable, pulleys, guides, and other individual components of a cable tensioning system for securing and stretching a printed display sheet on a billboard or sign.

### BACKGROUND

Display sheets in the form of printed words, photographs, or drawings on flexible semi-translucent media, such as vinyl, polyethylene, or polypropylene sheets attached to or stretched over a metal or wooden substrate forming an advertising billboard or commercial signage, have been in use for many years and known in the prior art. The display sheets are typically attached to the substrate, which forms the billboard face, by an apparatus, such as a cable tensioning system attached to either the front or the back the substrate. When a frontal attachment method is used, decorative trim is typically placed around the perimeter of the substrate and mounted several inches from the face of the substrate to conceal the attachment apparatus. The trim creates the appearance of a picture frame. However, unlike a picture frame there is a gap of several inches between the trim and the advertising display sheet. When the billboard is mounted high in the air above motorists or pedestrians, the gap is not generally noticeable. But when the billboard is located closer to the ground, the gap is noticeable and can be an undesirable distraction from the advertising display.

Another problem resulting from the gap between the border trim or frame and the substrate, or an exposed cable tensioning system is the accumulation of debris that can occur along the bottom portion of the billboard. On billboards mounted close to the ground, which is a prevalent practice in European and other countries outside of North America, drinking cups, bottles, and other trash is often placed in the gap, which can interfere with the operation of the system when the display face is changed. The trash can also pile up and block vision of a part of the display face and create a potential for injury to a worker removing broken bottles and other hazardous trash placed in the gap.

A recent frontal attachment apparatus and method is the cable tensioning system disclosed in U.S. Patent Application No. 20090019570 filed Jul. 16, 2007, comprised of cables, anchor plates, cable guides, and locking clips, which application is incorporated herein by this reference in its entirety. Each of the individual components of existing cable tensioning systems is attached directly to the substrate or to the support structure of the billboard using bolts or screws. Holes must be drilled in the substrate at specified locations for each cable guide and pulley. If the installer incorrectly places a component, the cable system may not function properly. For example, the cable may slip off an incorrectly placed cable guide. As a result, each incorrectly installed component must be removed, new holes drilled, and screws or bolts attached in the correct location.

Templates with mounting and hole drilling locations may be used on signs and smaller billboard but the use of templates for large billboards is impractical because of the size of the template required, the cost of the template, and the difficulty inherent in handling and attaching the template onto the billboard substrate. Another problem is when the cable tensioning system is positioned on the perimeter of the substrate it is exposed to the elements subjecting it to rust and other deterioration over time if left uncovered.

Therefore, it is readily apparent that there is a recognizable unmet need for an apparatus and method to house a cable tensioning system positioned around the perimeter of billboard, wherein a billboard with a cable tensioning system may be configured to fit one or more sizes and configurations of a billboard, to conceal the cable tensioning system, cover the gap between the frame and the display sheet, and eliminate the need for a separate border trim on around the perimeter of the billboard.

### SUMMARY

Briefly described, in example embodiment the present apparatus overcomes the above-mentioned disadvantages and meets the recognized need for an apparatus and method to house cable tensioning system positioned around the perimeter of a billboard comprising, in general, a trim base C-shaped channel having a front face, a bottom face, and a hanger face configured to form a trough or C-channel; one or more T-tracks and splice tracks positioned on the interior of the trough or C-channel for mounting a plurality of components of a cable tensioning system; a concave member positioned on the front face; a trim cap having a support extension and a contact extension configured to rotate about the concave member, wherein the trim cap is configured to cover the trough or open top of the C-channel; and a spring positioned between one hanger section and the support extension, wherein the spring is configured to rotate the trim cap about the concave member and, thus, functions to conceal from public view the cable, pulleys, guides, and other individual components of a typical billboard cable tensioning system used to secure and stretch a printed display sheet, and protects the components from weather, dust, and undesirable debris.

According to its major aspects and broadly stated, the present apparatus meets the recognized need for a border trim assembly comprising, in general, a C-channel member having a front section, a concave member positioned on the front section, a bottom section, a hanger section, and a trim cap having a support extension and a contact extension configured to rotate about the concave member, wherein the trim cap is configured to cover the gap, trough or open top of the C-channel.

In an exemplary embodiment, the apparatus and method to house a cable tensioning system around the perimeter of a billboard, includes a border trim assembly for a billboard having an exposed display sheet tension system for attachment of a display sheet to the billboard panel, the assembly comprising: a structure having a mount section configured to position the display sheet tension system, a hanger section configured to affix the structure to the billboard panel, and a support section; a concave member positioned on the support section; and a trim cap configured to rotate about the concave member, wherein the trim cap is configured to cover the display sheet tension system.

In another exemplary embodiment, the apparatus and method to house a cable tensioning system around the perimeter of a billboard includes a border trim assembly for a billboard having an exposed display sheet tension system for attachment of a display sheet to the billboard panel, the assembly comprising: a structure having a mount section configured to position the display sheet tension system, a hanger section configured to affix the structure to the billboard panel, and a support section; a concave member positioned on the support section; a trim cap configured to rotate about the concave member, wherein the trim cap is configured to cover the display sheet tension system; a spring positioned between the support section and the trim cap wherein the spring is configured to rotate the trim cap about the concave member.

In still a further exemplary embodiment, the method of covering an exposed display sheet tension system for attachment of a display sheet to the billboard panel includes the steps of providing a structure having a mount section configured to position the display sheet tension system, a hanger section configured to affix the structure to the billboard panel, and a support section, a concave member positioned on the support section, and a trim cap configured to rotate about the concave member, wherein the trim cap configured to cover the display sheet tension system, mounting the border trim assembly to the billboard frame, adjusting the trim cap to fit the gap between the display sheet and the support section, and positioning a leaf spring between the support section and the trim cap wherein the spring is configured to rotate the trim cap about the concave member to cover the display sheet tension system.

In still a further exemplary embodiment, the method of filling a gap between a billboard frame and a display sheet includes the steps of providing a border trim assembly, which further comprises a C-channel having a front section with one T-slot, a splice slot, or a combination splice and T-slot, and a concave member positioned on the front section; a bottom section with one or more T-slots; a hanger section with two or more T-slots configured to affix the C-channel to the billboard frame or billboard panels and one or more T-slots to affix components of a cable tensioning system within the trough of the C-channel; and a trim cap having a support extension and a contact extension configured to rotate about the concave member wherein the trim cap is configured to cover the gap; hanging the trim assembly to the billboard frame; adjusting the trim assembly to fit the gap between the display sheet and the billboard frame; and positioning a leaf spring between the hanger section and the support extension wherein the leaf spring is configured to rotate the trim cap about the concave member to cover the gap.

The present disclosure may utilize aluminum extrusions consisting of a C-channel trim base with two or more T-shaped channels or T-slots and a hinged cap with a leaf spring to facilitate opening and closing. Bolts inserted into the T-slots secure the extrusion to the frame or panel sections of the billboard, depending upon the make-up of the billboard structure. With an alternative embodiment, the trim base is mounted onto an L-shaped bracket, which has been attached to the billboard frame, a wall, or other flat surface. [Although “billboard” is used throughout this application, the present disclosure may also be used on smaller signs. Therefore, the use of “billboard” herein also includes “signs.”] Bolts and nuts in the T-slots secure cable guides, pulleys, and other cable tensioning system components. The aluminum extrusion can be virtually any length, but to facilitate ease of handling or comply with cargo shipping restrictions, the length of the extrusions can be cut into individual sections for handling ease and shipping compliance. During installation individual extrusion sections can be joined together where the sections abut with metal splice plates inserted into splice tracks on the interior of the C-channel member.

Accordingly, a feature of the apparatus to house a cable tensioning system around the perimeter of a billboard is its ability to provide a trim cap attached to the trim base with a ball and socket-type hinge.

Still another feature of the apparatus to house a cable tensioning system around the perimeter of a billboard is its ability to provide a concave member positioned at the top of the front face of the C-channel configured to form the socket into which the hinge pin of the trim cap is inserted to rotate within the concave member when the trim cap is opened and closed.

Yet another feature of the apparatus to house a cable tensioning system around the perimeter of a billboard is its ability to provide a leaf spring positioned between the mount leg on the top of the front face of the C-channel and the support extension of the trim cap to provide tension to open and close the trim cap.

Yet another feature of the apparatus to house cable tensioning system around perimeter of billboard is its ability to provide a base stop at the top of the front face configured to form a surface against which the stop leg on the trim cap strikes, preventing the cap from rotating beyond the stop or opening too far, which could allow the leaf spring to detach from the assembly.

Yet another feature of the apparatus to house a cable tensioning system around the perimeter of a billboard is its ability to provide a closing stop on the top surface of the hinge leaf spring mount, which is provided to prevent the trim cap from closing beyond 90 degrees or another desired angle and prevents the trim cap from separating from the trim base at the hinged connection.

Yet another feature of the apparatus to house a cable tensioning system around the perimeter of a billboard is its ability to provide a trim base having an elongated opening on the bottom section into which one leg of an L-shaped bracket can be inserted. Moreover, the other leg of the bracket is attached by bolts or screws to a wall eliminating the need for a metal or wood substrate backing

Yet another feature of the apparatus to house a cable tensioning system around the perimeter of billboard is its ability to provide one end of the leaf spring configured to lie in a groove in the leaf spring mount near the top of the front section and other end of the leaf spring configured to lie in a corresponding groove in the trim cap leaf spring mount located on the underside of the trim cap.

Yet another feature of the apparatus to house a cable tensioning system around the perimeter of billboard is its ability to provide a top portion of the trim cap configured to have a tool lip into which a tool with a flat blade such as a flat screw driver or hook can be inserted to open the trim cap.

Yet another feature of the apparatus to house a cable tensioning system around the perimeter of a billboard is its ability to provide a small gap between the top of the trim cap and the bottom of the tool lip to prevent pedestrians from opening the trim cap by hand.

Yet another feature of the apparatus to house a cable tensioning system around the perimeter of a billboard is its ability to provide a lock inserted into the cap to prevent the trim cap from being opened by others.

Yet another feature of the apparatus to house a cable tensioning system around the perimeter of a billboard is its ability to provide a gap between the top of the trim cap and the bottom of the tool lip large enough to allow opening of the trim cap by placing fingers into the gap and pulling the trim cap open without a tool. This is an exemplary embodiment on billboards installed in a location not accessible by the general public.

Yet another feature of the apparatus to house a cable tensioning system around the perimeter of a billboard is its ability to provide a trim cap with a length equal the width of the C-channel from the front face of the front section to the rear face of the mounting section, which results in the trim cap forming a 90 degree closure on the top of the C-channel.

Yet another feature of the apparatus to house a cable tensioning system around the perimeter of a billboard is its ability to provide a trim cap with a length configured to exceed the width of the C-channel, which results in the trim cap forming an angle slanting down from the display media to the front face of the front section. This is an exemplary embodiment on billboards mounted low to the ground. The downward angle of the trim cap will cause objects such as cups, bottles, and other objects to slide off the trim cap.

Yet another feature of the apparatus to house a cable tensioning system around the perimeter of a billboard is its ability to provide the contact end of the trim cap, which rests against the display media configured with a rounded hook or rounded bead to prevent the edge from catching or cutting the display media when the trim cap is opened and closed.

Yet another feature of the apparatus to house a cable tensioning system around the perimeter of a billboard is its ability to provide tension, created by the leaf spring, configured to cause the contact end of the trim cap to press against the display media, holding it against the substrate or panel sections. This tension helps to remove wrinkles in the display media.

Yet another feature of the apparatus to house a cable tensioning system around the perimeter of a billboard is its ability to provide a trim cap configured to reduces rain, snow and other damage to the tensioning system components.

Yet another feature of the apparatus to house a cable tensioning system around the perimeter of a billboard is its ability to provide a trim base having an angled baffle on the rear face above the mounting T-slots, wherein the display media runs across the apex of the baffle causing the display media to stretch smoothly across the face of the billboard. This is a exemplary embodiment for back-lit signs, in which a light source such as light emitting diodes (LED's), fluorescent tubes, or incandescent bulbs, are mounted on a back substrate providing illumination from behind the display media.

Yet another feature of the apparatus to house a cable tensioning system around the perimeter of a billboard is its ability to provide billboard trim that can accommodate various sizes and dimensions of billboards.

Yet another feature of the apparatus to house a cable tensioning system around the perimeter of a billboard is its ability to provide a hinge configuration between the C-channel and trim cap that is easy to assemble.

Yet another feature of the apparatus to house a cable tensioning system around the perimeter of a billboard is its ability to provide a C-channel member and trim cap configured to withstand the weather.

Yet another feature of the apparatus to house a cable tensioning system around the perimeter of a billboard is its ability to provide a trim cap that can accommodate various sizes of billboards and different sized gaps between the display sheet and the billboard trim.

These and other features of the apparatus and method to house a cable tensioning system around the perimeter of a billboard will become more apparent to one skilled in the art from the following Brief Description of the Drawings, Detailed Description, and Claims when read in light of the accompanying drawings.

### BRIEF DESCRIPTION OF THE DRAWINGS

Exemplary embodiments of the present disclosure are illustrated in the drawings in which like reference characters designate the same or similar parts throughout the figures of which:

FIG. 1 is a perspective view of an example embodiment of a corner portion with the hanger section and bottom section depicting typical locations of various cable tensioning system components within the C-channel trim assembly;

FIG. 2 is a side view of an example embodiment of the C-channel trim assembly with the trim cap in the open position;

FIG. 3 is a side view of an alternative example embodiment of the C-channel trim assembly with the cap in the closed position;

FIG. 4 is a side view of an alternative example embodiment of the C-channel trim assembly with the trim cap in the closed position with a bracket attached to the T-track and with an alternative trim cap lock;

FIG. 5 is a side view and frontal view of an example embodiment of a bracket;

FIG. 6 is a side view of an alternative example embodiment of the C-channel trim assembly attached to an LED backlit billboard panel section and depicts a display sheet attached to two components of a cable tensioning system;

FIG. 7 is a side view of an alternative example embodiment of the C-channel trim assembly attached to a billboard panel section with a hinge at the bottom of the C-channel, with the trim cap shown with two long legs and one short leg, and with a coil spring instead of a leaf spring;

FIG. 8A-8I is a side view of exemplary embodiments of different hinged trim caps that may be affixed to the C-channel member to form the C-channel trim assembly;

FIG. 9 is a side view of an alternative example embodiment of the C-channel trim assembly with a baffle and an extended bottom flange;

FIG. 10 is a perspective view of an example embodiment of a corner portion of the C-channel trim assembly in the closed position with a typical mitered corner; and

FIG. 11 is a flow diagram of a method of securing a C-channel trim assembly to the billboard frame. It is to be noted that the drawings presented are intended solely for the purpose of illustration and that they are, therefore, neither desired nor intended to limit the disclosure to any or all of the exact details of construction shown, except insofar as they may be deemed essential to the claimed invention

### DETAILED DESCRIPTION

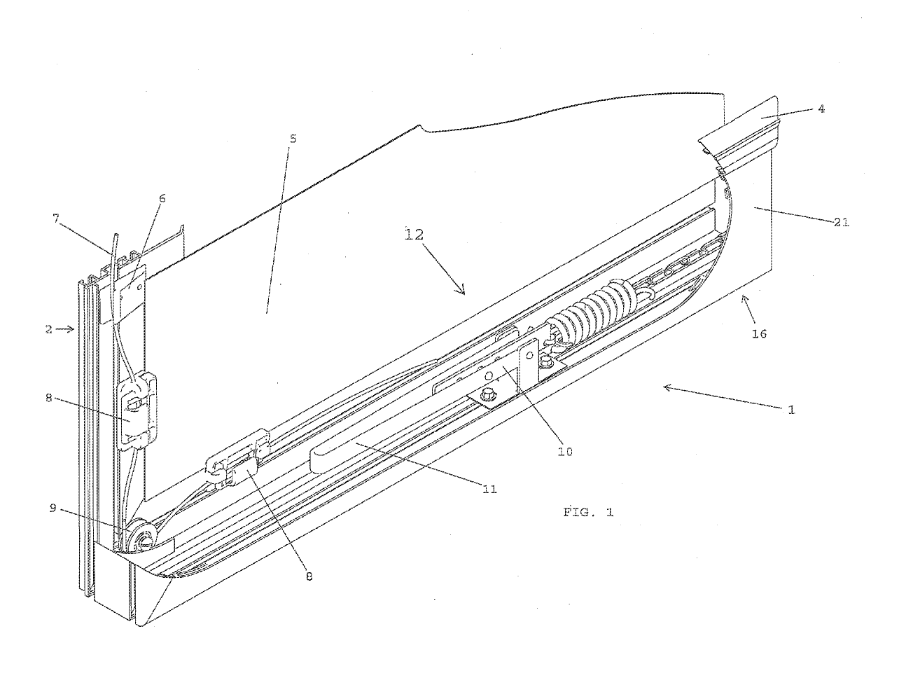

In describing the exemplary embodiments of the present disclosure, as illustrated in FIGS. 1-11, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

It is also understood that the described embodiments and aspects are merely examples and that structural and functional modifications can be made without departing from the scope of the present disclosure. In addition, the billboard or other frame formed by the housing described herein can have a variety of sizes and shapes such as, but not limited to, rectangular, square, or other polyhedral or irregular shape. One ordinarily skilled in the art would readily recognize that these and other variations can be made without departing from the scope of the present disclosure.

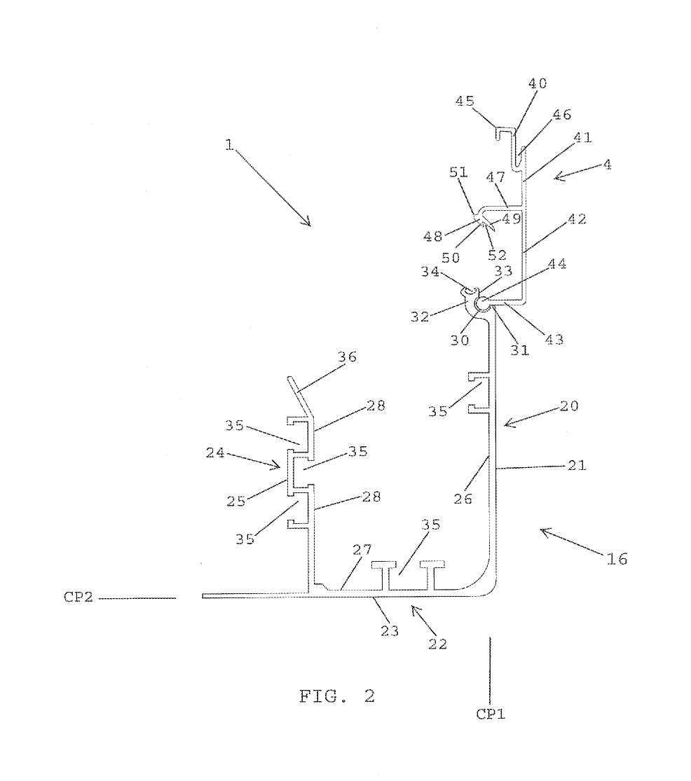

Referring now to FIG. 1, by way of example, and not limitation, there is illustrated an example embodiment of C-channel trim assembly 1. Preferably, billboard frame trim cover such as C-channel trim assembly 1 comprises the trim cover for the perimeter of the panel sections that form a billboard. C-channel assembly 1 preferably includes C-channel member 16, a pivotable cover such as trim cap 4, a mount section such as bottom section 22, a hanger or attachment section such as hanger section 24, and flange 36, as shown in FIG. 2. Trim cap 4 preferably covers the gap between front face 21 and display sheet 5. C-channel member 16 is preferably used to cover one or more sizes and configurations of billboard panel sections or frames, utilized to support moveable trim cap 4, and to prevent unwanted lateral or vertical motion of trim cap 4. Trim cap 4 is preferably used to fill the gap or trough formed by the sections of C-channel member 16 and to press against display sheet 5 being displayed on such billboard.

C-channel trim assembly 1 includes C-channel member 16, which preferably is cut at an approximately 45° angle at each corner when used on either a square or rectangular billboard, with front face 21 providing an attractive and protective cover over the billboard panel sections or frame. Trim cap 4 preferably provides a protective cover over the typical components of a display sheet tension system such as cable tensioning system 12 including cable guide 6, cable 7, locking tension clip 8, pulley 9, and spring loaded tension device 10. The tension from spring loaded tension device 10 is applied when hand lever 11 is moved to the closed position, depicted in FIG. 1. Alternatively, a winch or other device known to one ordinarily skilled in the art may be used to apply tension as an alternative to hand-levered spring loaded tension device 10.

It is contemplated herein that the billboard or other frame described herein may have a variety of sizes and shapes such as, but not limited to, rectangular, square, triangular, or other polyhedral or irregular shapes. In addition to billboards, C-channel trim assembly 1 may be used on signs, which are generally considered to be smaller in size than billboards. It is also contemplated herein that sections or integral sections of C-channel trim assembly 1 may include various configurations and sizes and such sections may be arranged proximate to one another to fit one or more sizes and configurations of the billboard frame.

C-channel member 16, trim cap 4, bottom section 22, hanger section 24, and flange 36 are preferably formed of a suitable material, such as aluminum, steel, iron, rigid plastic or plastic with metal inserts for strength, fiber, metal alloy, stainless steel, or the like, capable of providing structure to C-channel member 16, trim cap 4, bottom section 22, hanger section 24, and flange 36 as shown in FIG. 2 and C-channel trim assembly 1. Moreover, such material may be painted, powder coated, anodized, finished with different coatings known in the industry, or installed with no finish relying upon the natural color of the material utilized. Preferably, the material includes other suitable characteristics such as durability, rust-resistance, light weight, heat-resistance, chemical inertness, oxidation resistance, ease of workability, or other beneficial characteristics understood by one ordinarily skilled in the art. Moreover, C-channel trim assembly 1 preferably is re-useable in that C-channel trim assembly 1 may be repeatedly affixed to any one of one or more sizes, styles, and configurations of billboards.

Referring now to FIG. 2, there is illustrated a side view of an example embodiment of C-C-channel trim assembly 1 shown in the open position. Specifically, C-channel member 16 preferably includes extruded, stamped, shaped, bent or formed sections including a support section such as front section 20 with front face 21 and interior front face 26, bottom section 22 with bottom face 23 and interior bottom face 27, and hanger section 24 with mount face 25 and interior mount face 28. Flange 36, preferably positioned at the top of hanger section 24, aids installation of the cable tensioning components. Preferably, front section 20 extends in a first common plane CP1, and bottom section 22 extends in a second common plane CP2, and hanger section 24 extends in first common plane CP1. Moreover, first common plane CP1 preferably runs perpendicular or approximately perpendicular to second common plane CP2. Preferably, front section 20, bottom section 22, and hanger section 24 are preferably configured to have dimensions to encase, cover and affix to the panel sections or frame around the perimeter of the billboard. In FIG. 2, bottom section 22 is extended beyond hanger section 24 as an alternative embodiment to cover or conceal the billboard frame or panel member ends.

Front section 20 of C-channel member 16 preferably includes an attachment mechanism or slotted channel such as T-track 35 extending inwards from first common plane CP1, as depicted in FIG. 2, from interior front face 26 configured to secure brackets or splices to C-channel member 16. The top or first end of front section 20 preferably terminates approximately in second common plane CP2 forming hinge stop 31. Leaf spring mount 32 curves inwards and upwards from interior front face 26 near the top or first end of front section 20 or approximate hinge stop 31 forming a concave member such as hinge 30. Leaf spring mount 32 preferably terminates with a first spring mount such as groove 34 into which one end of a leaf spring may be inserted. Stop 33 preferably prevents trim cap 4 from closing beyond approximately ninety degrees (90°) to first common plane CP1 or to such other desired angle when hinge pin extension 43 strikes stop 33.

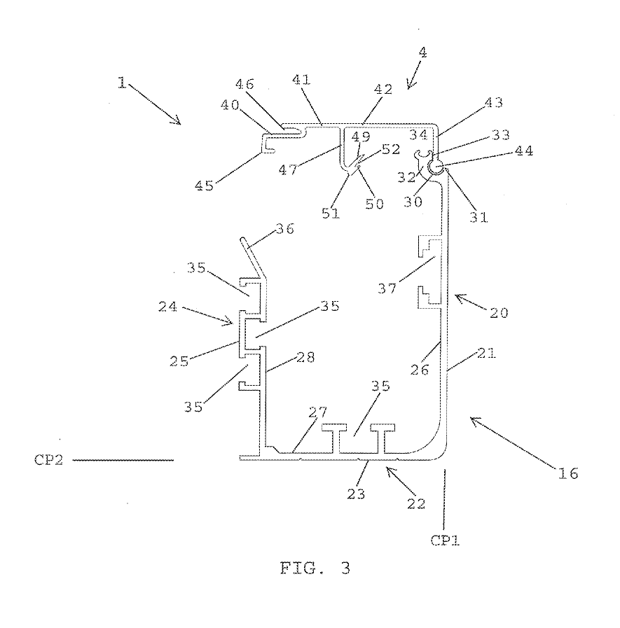

Leaf spring mount 32 preferably extends inward in an arc from hinge stop 31 and is preferably configured to partially encompass hinge pin 44 to enable trim cap 4 to be in rotational pivot about C-channel member 16. Hinge 30 is preferably configured in an arc such as C-shaped and runs the approximate length of leaf spring mount 32. Leaf spring mount 32 preferably enables hinge pin 44 to rotate within hinge 30, specifically clockwise to the open position as shown in FIG. 2 and counter-clockwise to the closed position as shown in FIG. 3 relative to first common plane CP1, whereby trim cap 4 rotates about C-channel member 16.

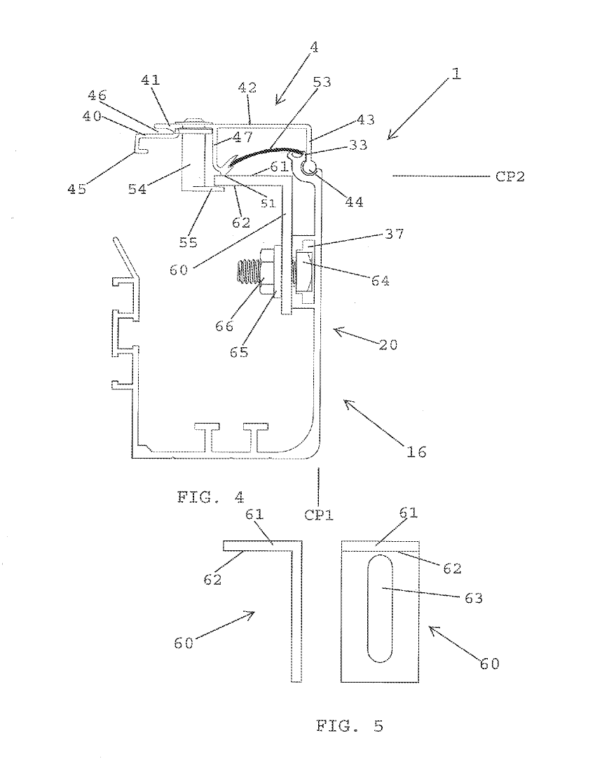

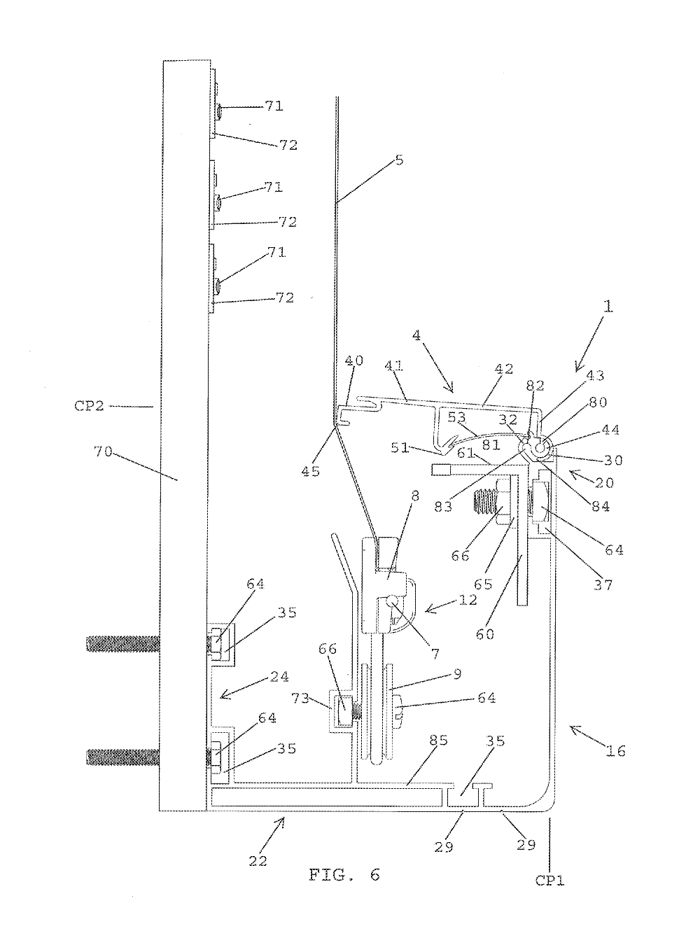

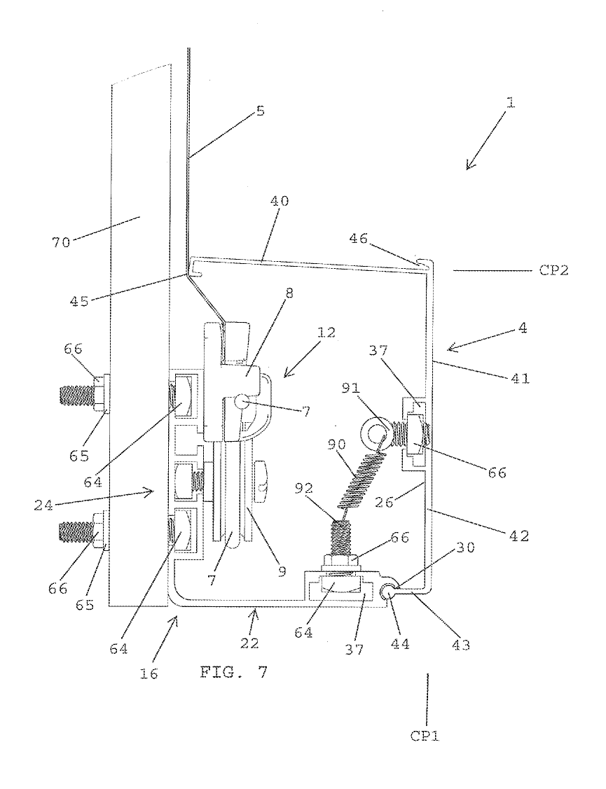

Front section 20 is situated at an approximately ninety degree (90°) angle to second common plane CP2 and preferably further includes, at one end, a grooved receptacle for a spring or bias element such as leaf spring 53 (shown in FIGS. 5 and 6) and an arcing circular surface pivot forming hinge 30, which partially surrounds hinge pin 44. Groove 34 in leaf spring mount 32 is preferably configured to releasably retain one end of a bias element such as leaf spring 53 in a compressed state. It is contemplated herein that leaf spring 53 (shown in FIG. 4) may be configured from any biasing or spring element known to one of ordinary skill in the art. Front face 21 of C-channel member 16 preferably faces the viewer of the billboard. It is recognized that C-channel member 16 may be configured as one or may be pieced together and formed from separate components and may be configured in other sizes and shapes to form a recess that accommodates the size and dimensions of the trim around the perimeter of the billboard.

Referring again to FIG. 2, the gap, cover or extension member such as trim cap 4 preferably includes extruded, stamped, shaped, bent or formed sections, such as hinge pin extension 43, mount extension 42, support extension 41, contact extension 40, and additionally may include a handle or grip such as opening lip 46. Preferably, when trim cap 4 is in the open position, hinge pin extension 43 and leaf spring extension 47 extend approximately in a first second common plane CP2, while mount extension 42, support extension 41, and contact extension 40 extend approximately in a first common plane CP1. At a first end, hinge pin extension 43, preferably includes a rotational pin or rib pivot member such as hinge pin 44 capable of being contained in part within hinge 30 thereby releasably retaining trim cap 4 in rotational pivot about C-channel member 16. Hinge pin 44 is preferably a circular solid bead or rib that runs the approximate length of trim cap 4 as shown running into the figure page. In addition, at a second end, hinge pin extension 43 preferably terminates at a ninety degree (90°) angle upwards, forming a first end of mount extension 42. At a second end, mount extension 42 terminates with leaf spring extension 47, which preferably includes a mount such as leaf spring mount 48 configured to releasably retain the other end of a spring such as leaf spring 53 in a compressed state. Together, leaf mount 48 of trim cap 4 and groove 34 on leaf spring mount 32 of C-Channel member 16 are preferably configured each to hold an end of leaf spring 53 in a compressed state. One end of leaf spring 53 is preferably inserted into groove 34 of leaf spring mount 32 of front section 20 and the other end of leaf spring 53 is preferably inserted into leaf spring mount 48 of trim cap 4. Leaf spring 53 preferably biases trim cap 4 in the closed position shown in FIG. 3 and FIG. 4. Preferably, hinge pin extension 43, mount extension 42, support extension 41, and contact extension 40 may be configured to any desired length and configured as adjoining sections. It is recognized herein that leaf spring 53 may be positioned between leaf spring mount 32 and leaf spring extension 47.

Referring again to FIG. 2, at a first end, hinge pin 44 connects to hinge pin extension 43 and preferably connects, at a first end, to mount extension 42, which connects to support extension 41. The second end of support extension 41 preferably includes a bifurcated end having a handle formed from opening lip 46 and contact extension 40. At its second end, contact extension 40 includes contact end 45, which presses against the display sheet. Contact end 45 is preferably curved or angled to provide a smooth surface to contact the display sheet of the billboard. Opening lip 46 is preferably utilized to grip support extension 41 of trim cap 4 to manually disengage contact extension 40 and contact end 45 from being in contact with the display sheet (as shown in FIG. 6). Preferably, pivotable rotation of hinge pin 44 in hinge 30 causes hinge pin extension 43, mount extension 42, and support extension 41 to rotate about hinge 30.

It is contemplated herein that trim cap 4 may be configured as one unit or may be pieced together and formed from separate components and may be configured in various sizes and shapes to form a cover that accommodates the gap or trough between the display sheet and front section 20.

One advantage of the hinge configuration depicted in FIG. 2 is the ease in which trim cap 4 is preferably attached to front section 20 of C-channel member 16. To install, hinge pin 44 is preferably laterally inserted into hinge 30 of C-channel member 16 (as illustrated in FIG. 2), with trim cap 4 preferably in the open position. One end of leaf spring 53 is preferably inserted into groove 34 of leaf spring mount 32 of C-channel member 16 and the other end of leaf spring 53 is preferably inserted into leaf spring mount 48 of trim cap 4. It is contemplated herein that leaf spring 53 may be a single unit or one or more units positioned at one or more appropriate intervals, specifically positioned at approximately 24 inches to 36 inches intervals, to create sufficient tension to secure trim cap 4 in position relative to front section 20 of C-channel member 16 relative to second common plane CP2. Moreover, hinge 30 is preferably configured to releasably retain hinge pin 44 of trim cap 4 to enable trim cap 4 to be in rotational pivot about front section 20 of C-channel member 16.

It is contemplated herein that hinge pin 44 and hinge 30 may extend approximately the full length or comprise partial length sections along trim cap 4 and C-channel member 16, respectively. It is further contemplated herein that hinge pin 44 and hinge 30 may be reversed so that hinge pin 44 were formed on front section 20 of C-channel member 16 and hinge 30 were formed on trim cap 4, respectively as shown in FIG. 6. It is still further contemplated herein that hinge pin 44 and hinge 30 may be configured from any rotational or pivoting apparatus known to one ordinarily skilled in the art.

Bottom section 22 of C-channel member 16 preferably includes bottom face 23, interior bottom face 27, and T-track 35, and a first end of bottom section 22 is preferably connected to and positioned at a ninety degree (90°) angle to a second end of front section 20 in first common plane CP1. T-track 35 extends upwards from second common plane CP2 and from interior bottom face 27 of bottom section 22, as depicted in FIG. 2, and provides a track for securing items such as various cable tensioning components to bottom section 22.

Hanger section 24 of C-channel member 16 preferably includes mount face 25, interior mount face 28, and two or more T-tracks 35, at least two of which open outwardly from hanger section 24 and are preferably utilized for mounting C-channel member 16 to billboard panel sections or frame members, wall brackets, wall, or other mounting surface or device known to one ordinarily skilled in the art. Hanger section 24 is preferably position at a ninety degree (90°) angle to second common plane CP2 and a first end of hanger section 24 is preferably connected to a second end of bottom section 22. One or more T-tracks 35 open inwardly from hanger section 24 and are preferably utilized for mounting cable tensioning components in the trough of C-channel member 16 between interior front face 26 and interior mount face 28. Flange 36 preferably a first end of hanger section 24 is angled at approximately thirty-five degrees (35°) from first common plane CP1 or such other desired angle away from interior mount face 28 towards mount face 25 to ease or guide placement of the cable on the cable pulleys and other components of the cable tensioning system when C-channel member 16 is mounted on the top or side of a billboard. Typically such placement is accomplished using a long rod with a cable installation tool at one end. Flange 36 preferably prevents the tool head from catching on the top of hanger section 24.

Referring now to FIG. 3, there is illustrated a side view of an example embodiment of C-channel trim assembly 1 of FIG. 2 shown in the closed position. Preferably, in the closed position, hinge pin extension 43 of trim cap 4 rests against stop 33 on leaf spring mount 32 to prevent trim cap 4 from closing further than approximately ninety degrees (90°) from first common plane CP1 or such other desirable angle determined by the location of stop 33 and the relative position or angle of hinge extension 43. In an alternative embodiment, bottom section 22 preferably includes one or more apertures or slots such as drilling groove 29 to facilitate drilling weep holes to drain rain water and other liquids at intervals along the latitudinal length of bottom section 22 when C-channel member 16 is latitudinally positioned on the bottom of a billboard frame or panel member.

In an alternative embodiment, a dual purpose attachment mechanism or slotted channel such as splice/nut track 37 replaces of T-track 35 as shown in FIG. 2 is positioned inwardly from first common plane CP1 on interior front face 26 of front section 20. Splice/nut track 37, which like its counterpart T-track 35, preferably extends continuously the full length of C-channel member 16, may be used with a bolt head or a nut to secure cable tensioning components or other desired parts to C-channel member 16, or may be used with an adjoining bar such as a flat splice bar to strengthen the joint between abutting sections of C-channel members such as front section 20 and bottom section 22 or at the corners with a ninety degree (90°) L-shaped splice bar between abutting sections of C-channel members such as front section 20 and bottom section 22. Typically, a splice bar may be three to six inches long by three quarters of an inch wide by one eighth of an inch thick, although the dimensions may be appropriately adjusted by one ordinarily skilled in the art based upon the composition of the materials and dimensions of the C-channel members used.

Referring now to FIG. 4, there is illustrated C-channel trim assembly 1 in the closed position with alternative embodiment disclosing a lock mechanism such as cap lock 54 shown in the locked position as a result of the rotational engagement of locking flange 55 against bracket bottom 62 of bracket 60. In this example embodiment, splice/nut track 37 preferably secures the head of bolt 64. Splice/nut track 37 is preferably positioned approximate front section 20 of C-channel member 16 and is sized to allow an attachment device such as square-headed or hex-headed bolt 64 to slide within splice/nut track 37, whereby splice/nut track 37 is configured to capture square-headed or hex-headed bolt 64 to prevent bolt 64 from rotating when nut 66 is screwed onto the threads of bolt 64. Moreover, splice/nut track 37 is preferably configured to accommodate attachment mechanism such as bolt 64, washer 65, and nut 66 to secure a latch mechanism such as L-shaped bracket 60 to splice/nut track 37 and front section 20 of C-channel member 16. Although splice/nut track 37 is depicted in FIG. 4, T-track 35 may alternatively be used as determined by one of ordinary skill in the art.

When trim cap 4 is rotated from the open position (FIG. 3) to the closed position (FIG. 4), stop 33 prevents trim cap 4 from rotating beyond approximately ninety degrees (90°) relative to first common plane CP1 or such other desired angle determined by the shape and size of hinge pin extension 43 and stop 33. Preferably, adjustable elevation of bracket 60 may provide additional support in stopping the rotation of trim cap 4 or may stop the rotation before hinge pin extension 43 comes into contact with hinge stop 33 thereby raising or decreasing the angle (from approximately ninety degrees [90°]) at which trim cap 4 would otherwise stop. When trim cap 4 is moved from the open position to the closed position and bracket 60 is attached to C-channel 16, nub 51 at the second end of leaf spring extension 47 strikes bracket top 61 preventing cap 4 from closing beyond a desired angle determined by the adjustable height of bracket 60 relative to second common plane CP2.

Referring now to FIG. 5, there is illustrated a side view and front view of an example embodiment of L-shaped bracket 60. L-shaped bracket 60 preferably includes a longitudinally elongated aperture such as opening 63, which is configured to allow the height of L-shaped bracket 60 to be adjusted up or down relative to splice/nut track 37 and front section 20 of C-channel member 16, shown in FIG. 4. The height of L-shaped bracket 60 preferably sets the closed position angle (relative to second common plane CP2) between trim cap 4 and C-channel member 16 via rotational pivot about hinge pin 44 and hinge 30.

Referring now to FIG. 6, there is illustrated a side view of an alternative example embodiment of C-channel trim assembly 1 in the closed position with an alternative hinge and pin configuration. Bolt 64 preferably in splice/nut track 37 with nut 66 and washer 65 secures L-shaped bracket 60 to front section 20 of C-channel member 16. Hinge 30 and hinge pin 44 are shown reversed from that shown in FIGS. 2-4. In this embodiment, the hinge is preferably formed as a circular tube such as hinge pin 44 that runs the approximate length of C-channel member 16. Hinge pin 44 may preferably include opening 80 near the top of the circular tube for the purpose of an efficient method of forming a tube in the extrusion process. In this alternate embodiment, hinge pin mount 81 may curve from the top of front section 20 to form recess 83 and hinge stop 82. Hinge pin 44 is preferably formed as a rotational couple member to hinge 30 and is preferably configured to releasably retain trim cap 4 in rotational pivot about C-channel member 16. Recess 83 preferably enables hinge 30 to rotate about circular tube hinge pin 44, specifically counter-clockwise in the orientation depicted in FIG. 6 from trim cap 4 in an open position (shown in FIG. 3) to the closed position (shown in FIG. 6). Moreover, recess 83 is preferably configured to act as a stop such as hinge stop 82 to prevent trim cap 4 from opening beyond a desired angle (relative to first common plane CP1), which typically is approximately ninety degrees (90°) from the closed position. Still further, stop 82 of recess 83 formed by hinge pin mount 81 is preferably configured to prevent trim cap 4 from opening beyond a preferable angle determined by the combined rotational depth of recess 83 and the length of leading edge 84 of hinge 30. Moreover, leaf spring mount 32 preferably protrudes out of circular tube hinge pin 44 at or near the ten o'clock and eleven o′clock position of circular tube hinge pin 44.

It is contemplated herein that circular tube hinge pin 44 may be configured without opening 80 but would rather be configured as a solid tube that runs the approximate length of C-channel member 16. In still another embodiment, instead of a tube, hinge pin 44 may be configured as a solid circular bead or rib. One ordinarily skilled in the art would recognize that less material is required, and therefore less cost incurred, using a tube with an opening near the top rather than a solid circular bead or rib for hinge pin 44.

The adjustable elevation of bracket 60, which bracket stops the rotation of trim cap 4 when nub 51 comes into contact with bracket top 61, and enables the angle of trim cap 4 in the closed position to be increased or decreased from a preferable ninety degree [90°]) angle relative to second common plane CP2.

In this example embodiment, bottom section 22 is preferably lengthened to increase the distance between display sheet 5 and panel section 70 onto which a light source such as LED bulbs 71 and circuit boards such as LED circuit boards 72 are mounted for a typical backlit billboard, which is known by one ordinarily skilled in the art to require a space of several inches or more between the light source and the display sheet, the distance depending upon the number and type of light sources used, such as LED bulbs. T-track 35 in bottom section 22 may be configured for mounting a spring loaded tension device such as cable tensioning system 12. Pulley 9 is preferably attached to T-track mount 73 with bolt 64 and nut 66, with cable 7 to which locking tension clip 8 is attached moveably running between the shoulders of pulley 9.

Bottom section 22 and mount plate 85 may be extended relative to T-track mount 73 to the preferred length to separate display sheet 5 from LED bulbs 71. Mount plate 85 is an alternative exemplary embodiment extending from T-track 35 of bottom section 22 relative to second common plane CP2 or parallel to bottom section 22 to T-track 35 of hanger section 24. Mount plate 85 preferably provides the base for T-track mount 73 and provides additional strength to hanger section 24, which supports the weight of C-channel trim assembly 1 when secured to panel section 70 or the billboard frame with bolts 64 or other mechanical fasteners. The corners where bottom section 22 of C-channel member 16 meets front section 20 and hanger section 24 may be preferably reinforced as depicted in FIG. 6, or alternatively in FIG. 2, or in a similar manner known by one ordinarily skilled in the art. In addition, the longitudinal length of hanger section 24 may be extended to separate T-tracks 35 within hanger section 24 to provide sufficient holding force to support the attachment of C-channel trim assembly 1 to panel section 70 with bolts 64 or other mechanical fasteners.

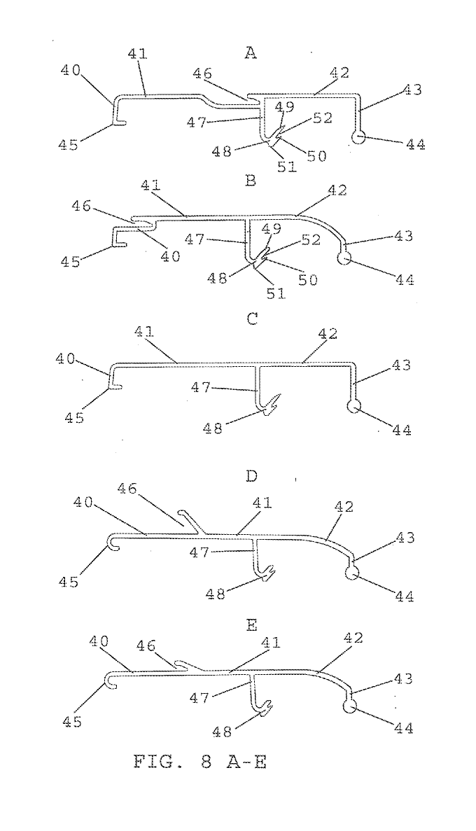

Referring now to FIG. 7 there is illustrated a side view of another alternative example embodiment. L-Channel member 16 replaces C-Channel member 16 and preferably includes L-Channel 1, L-shaped trim cap 4, and coil spring 90. L-Channel 1 replaces C-Channel 1 as shown in FIGS. 2, 3, 4, and 6, and includes bottom section 22 and hanger section 24. Moreover, L-shaped trim cap 4 preferably includes one or more extensions, such as hinge pin extension 43, mount extension 42, support extension 41, and contact extension 40 extending at approximately ninety degree (90°) angles. Still further, the leaf spring of FIGS. 2, 3, 4, and 6 is replaced by a biasing element such as coil spring 90. Coil spring 90 preferably provides closing tension when trim cap 4 is rotated from the closed position shown in FIG. 7 to the open position, and vice versa. L-shaped trim cap 4 comprises hinge pin 44 at its first end and terminates at its second end at an approximate ninety degree (90°) angle relative to hinge pin extension 43, which is the first end of mount extension 42. A second end of mount extension 42 and a first end of support extension 41 connect at T-track 35, which extends inwardly relative to first common plane CP1 and secures eyebolt 91 with nut 66. The second end of mount extension 41 of L-shaped trim cap 4 terminates at an approximate ninety degree (90°) angle relative to first common plane CP1 where it meets the first end of contact extension 40 with opening lip 46 atop mount extension 41 (as depicted in FIG. 7) providing tool access to open trim cap 4 when under tension from coil spring 90. Contact end 45 at the second end of contact extension 40 is preferably rounded to provide a smooth surface where contact end 45 presses against display sheet 5 to prevent scratching or snagging of display sheet 5 and to cover the cable tensioning system 12.

In an alternative to eyebolt 91, a bolt with a hole near the end of the threaded section may be used. Further, bolt 64 preferably extends upward relative to bottom section 22 from splice/nut track 37 positioned in bottom section 22. Anchor coil spring 90 is preferably attached at one end to eyebolt 91 and at the second end to hole 92 at the end of bolt 64 preferably extending upwards relative to bottom section 22. Hanger section 24 is configured similar to hanger section 24 described above in FIG. 2 with the exception of an alternative example embodiment of a curved approximate ninety degree (90°) angle upward relative to bottom section 22 and reinforcement of the corner where bottom section 22 and hanger section 24 connect.

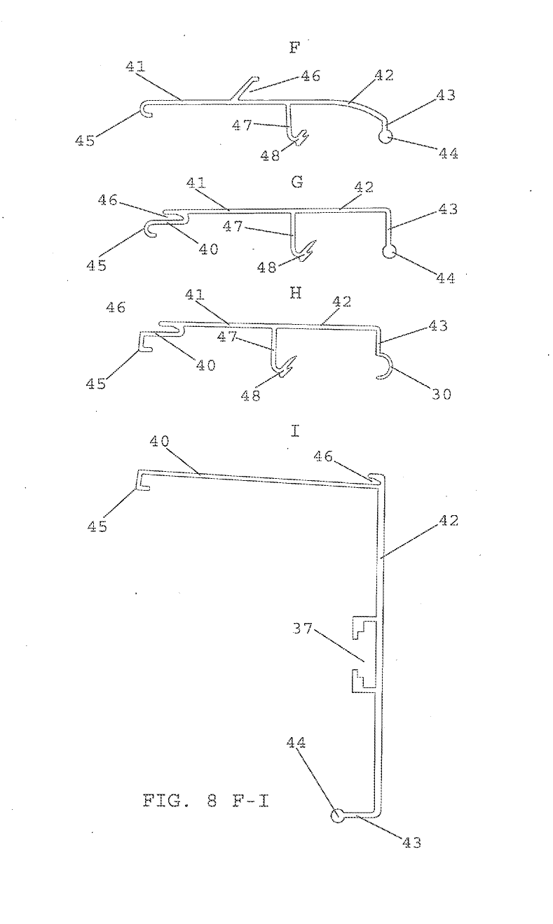

Referring now to FIG. 8, there are illustrated nine side view example embodiments of trim cap 4 (A through I). It is contemplated herein that all embodiments of trim cap 4 may contain common characteristics that can vary in size, shape, and position. As depicted in the side views in FIG. 8A-8F, these common characteristics are hinge pin 44, hinge pin extension 43, mount extension 42, support extension 41, contact extension 40, leaf spring extension 47, leaf spring mount 48, and contact end 45. Preferably, leaf mount extension 47 extends downward from the connection point between mount extension 42 and support extension 41 (from the orientation depicted in FIG. 8) and terminates at leaf spring mount 48. Leaf spring mount 48 preferably includes upper lip 49 and lower lip 50, which form a second spring mount such as groove 52 into which one end of leaf spring 53 may be inserted. Upper lip 49 is preferably longer in length than lower lip 50 as depicted in FIGS. 8A-8C, 8G, and 8H. It is recognized that longer upper lip 49 preferably extends from the base of leaf mount 48 and is configured to facilitate the insertion of leaf spring 53 into leaf mount 48. Nub 51 is preferably configured as a stop or contact point for trim cap 4 in the closed position.

To facilitate rotational opening of trim cap 4 when under tension from leaf spring 53 or alternative embodiment coil spring 90, opening lip 46 may preferably be positioned in a variety of locations along support extension 41 and may include one or more sizes and configurations to leverage against the tension created by leaf spring 53 or coil spring 90. FIG. 8D illustrates opening lip 46 large enough for insertion of adult-sized fingers to open trim cap 4. Finger-size openings may be advantageous on billboards not accessible to the general public, such as billboards mounted high above the ground.

On billboards accessible to the general public, a trim cap that can only be opened with a specialized tool or a common tool such as a screw driver may be desirable. FIGS. 8A, 8B, 8E, 8G, 8H and 8I depict example embodiments of trim cap 4, which may require a specialized opening tool or a screw driver. Preferably, in these figures opening lip 46 extends at a narrow angle upward from support extension 41 (contact extension 42 in FIG. 8A and contact extension 40 in FIG. 8I. The gap or groove formed between support extension 41 and opening lip 46 may be large enough for insertion of the end of a common screw driver or special tool to provide leverage to open trim cap 4.

FIG. 8B depicts opening lip 46 at the second end of support extension 41 similar to trim caps 4 depicted in FIG. 2-4. In FIG. 8A support extension 41 preferably includes recessed tool opening 93 integrated with lip 46, and configured to prevent opening of trim cap 4 with a common screw driver. In this example embodiment trim cap 4 preferably requires a specialized tool with a 90° angled blade for insertion into recessed opening lip 93 to open trim cap 4. FIG. 8C depicts trim cap 4 without any opening lip, which may be desirable on trim housing assemblies in which there is relative weak tension created by leaf spring 53 or where C-channel trim assembly 1 is installed on a billboard on which the display sheet is permanent or seldom changed. FIG. 8H depicts trim cap 4 with hinge 30 instead of hinge pin 44 at the first end of extension 43. FIG. 8I depicts an alternative embodiment of trim cap 4 for use with L-channel trim assembly 1 depicted in FIG. 7, in which hinge pin 44 and hinge 30 are situated at the end of bottom section 22 of L-channel member 16, and splice/nut track 37 is situated on the interior of mount extension 42.

It is contemplated herein that sections or integral sections of trim cap 4 may include various configurations and sizes and such sections may be arranged proximate one to another to fill the gap between the display sheet and the billboard panel sections or frame. Moreover, except for the reverse hinge configuration using hinge cap 4 depicted in FIG. 8H, each embodiment of trim cap 4 preferably includes contact end 45 at one end of trim cap 4 and hinge pin 44 on the opposite end. Contact end 45 is preferably rounded or angled to prevent cutting or scraping of the display sheet when trim cap 4 is in the closed position.

In an example embodiment, applicable to all but FIG. 8I, the length of trim cap 4 from hinge pin 44 to contact end 45 is approximately twice the length of the gap between billboard panel section 70 and front section 20 of C-channel 16. Preferably, an approximate forty-five degree (45°) angle on the trim cap 4 of C-channel trim assembly 1 running along the bottom of the billboard prevents pedestrians from placing bottles, cans, and other unwanted debris within the billboard's trim housing assembly or on trim cap 4. In another example embodiment, the length of trim cap 4 from hinge pin 44 to contact end 45 is preferably equal to or slightly longer than the length of the gap between front section 20 and hanger section 24. When trim cap 4 is closed, it forms approximately a ninety degree (90°) angle (relative to first common plane CP1) or close to it if said length is slightly longer. The slightly longer length of trim cap 4 assures that contact end 45 will press against display sheet 5 creating additional tension on the display sheet and preventing rain water, dirt, and other unwanted substances or materials from entering the billboard's trim housing assembly, cable tensioning system or other media display system.

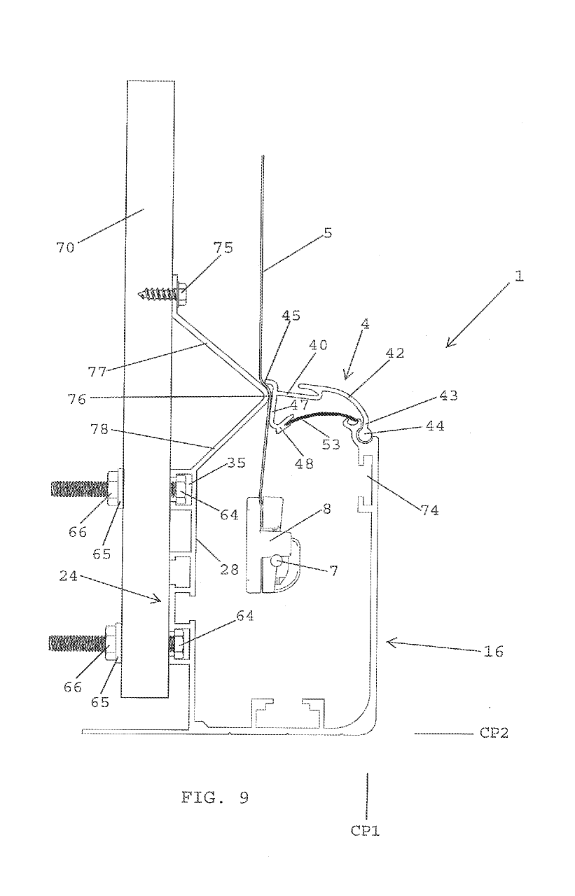

Referring now to FIG. 9, there is illustrated a side view of an alternative example embodiment of C-channel trim assembly 1 in the closed position with triangular shaped protrusion such as baffle 76 projecting inwardly relative to panel section 70 from the second end or top of hanger section 24. Preferably, lower section 78 of baffle 76 is configured projecting from interior mount face 28 but may alternatively project from hanger section 24 where it contacts the surface of panel section 70. Screw 75 preferably secures upper section 77 of baffle 76 to panel section 70. Baffle 76 preferably aids the tensioning and smoothing of display sheet 5 by providing a consistent point of contact against which display sheet 5 rests when tension is applied by cable 7 to locking tension clip 8, which grips the edge of display sheet 5, and by tension applied by contact end 45 of trim cap 4 against the apex point of baffle 76, which tension is created by leaf spring 53.

It is contemplated herein that baffle 76, including upper section 77 and lower section 78 may have a variety of sizes and shapes such as, but not limited to, triangular, arc, other polyhedral or irregular shape.

In the closed position, contact end 45 of trim cap 4 preferably rests approximately on the apex of baffle 76 with display sheet 5 between baffle 76 and contact end 45 and serves to stop the rotation of trim cap 4 when rotated from the open to closed position. This configuration eliminates the need for bracket 60 as a stop as depicted in FIGS. 5 and 6. A splice bar may be inserted into an attachment mechanism or slotted channel such as splice track 74 for additional support where C-channel members 16 abut. Bolts 64 along with washers 65 and nuts 66 or other mechanical fasteners may be used to attach C-channel trim assembly 1 to panel section 70 or the billboard frame.

It is contemplated herein that the attachment mechanisms set forth in FIGS. 2, 3, 4, 6, 7, and 9 such as T-tracks 35, splice/nut track 37, bolt 64, washer 65, nut 66, screw 75, and splice track 74 may be configured in a variety of sizes, shapes, and configurations to accommodate affixing C-channel assembly to panel section 70.

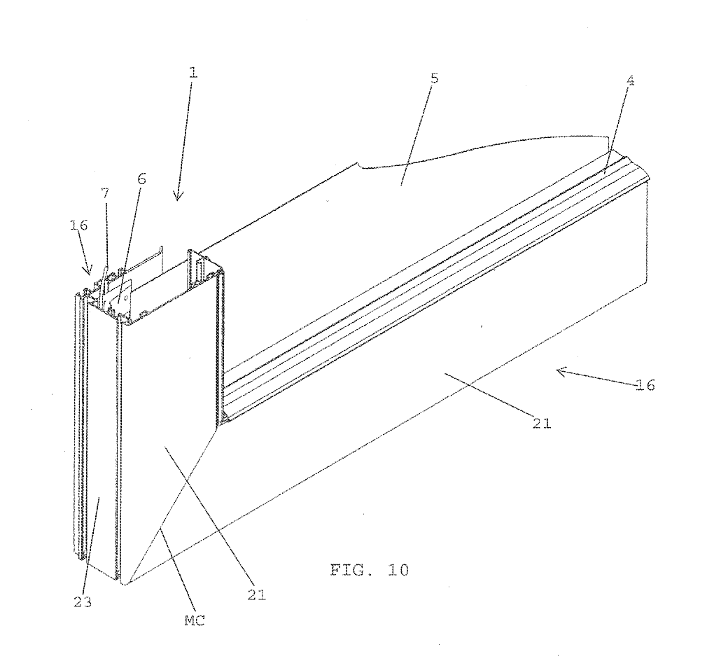

Referring now to FIG. 10, there is illustrated a perspective view of an example embodiment of C-channel trim assembly 1 shown in the closed position with a typical mitered corner MC. Front face 21 preferably faces the viewer of the billboard, providing a smooth and visually pleasing picture frame-type of trim around the perimeter of the billboard. Bottom face 23 and trim cap 4 cover the gap between front face 21 and display panel 5, hiding the interior of C-channel trim assembly 1, including cable guide 6, cable 7, and other components of the cable tensioning system 12 from public view.

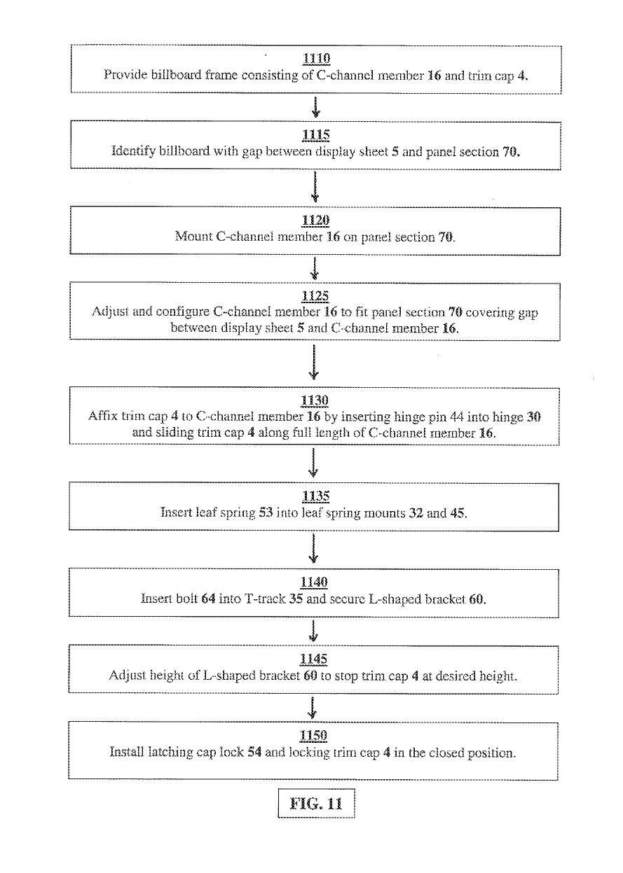

Referring now to FIG. 11, there is illustrated a flow diagram 1100 of a method of filling the gap between a billboard frame or panel sections and a display sheet by affixing C-channel trim assembly 1 to a billboard frame or panel section. In block or step 1110, providing billboard frame, which comprises C-channel member 16 and trim cap 4 as described above in FIGS. 1-10. In block or step 1115, identifying a billboard with a gap between the display or media sheet and billboard panel section 70. In block or step 1120, mounting said C-channel member 16 to the billboard panel section 70. In block or step 1125, adjusting and configuring C-channel member 16 to fit panel section 70 to cover the gap between the display sheet and C-channel member 16. In block or step 1130, affixing trim cap 4 to C-channel member 16. In block or step 1135, inserting leaf spring 53 into leaf spring mounts 32 and 45 to bias trim cap 4 in a closed position to cover such gap. In block or step 1140, inserting bolt 64 into T-track 35 and securing L-shaped bracket 60. In block or step 1145, adjusting the height of L-shaped bracket 60 to stop trim cap 4 at desired height. In block or step 1050, installing latching cap lock 54 and locking trim cap 4 in the closed position.

The foregoing description and drawings comprise illustrative embodiments of the present invention. Having thus described exemplary embodiments, it should be noted by those ordinarily skilled in the art that the within disclosures are exemplary only and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention having been described in detail, it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A border trim assembly for a billboard having an exposed display sheet tension system for attachment of a display sheet to the billboard panel, the assembly comprising:
a structure having a mount section configured to position the display sheet tension system, a hanger section configured to affix said structure to the billboard panel, and a support section;
a concave member positioned on said support section; and
a trim cap configured to rotate about said concave member, wherein said trim cap configured to cover the display sheet tension system.

2. The border trim assembly of claim 1, wherein said hanger section configured to receive an attachment mechanism.

3. The border trim assembly of claim 2, wherein said attachment mechanism configured to secure said structure to the billboard panel.

4. The border trim assembly of claim 2, wherein said attachment mechanism further comprises a slotted channel to secure a head of a bolt.

5. The border trim assembly of claim 4, wherein said bolt configured to secure said structure to the billboard panel.

6. The border trim assembly of claim 1, wherein said hanger section further comprises at least one flange configured to guide placement of the display sheet tension system.

7. The border trim assembly of claim 1, wherein said mount section configured to receive an attachment mechanism.

8. The border trim assembly of claim 7, wherein said attachment mechanism configured to secure the display sheet tension system.

9. The border trim assembly of claim 7, wherein said attachment mechanism further comprises a slotted channel to secure a head of a bolt.

10. The border trim assembly of claim 9, wherein said bolt configured to secure the display sheet tension system to said structure.

11. The border trim assembly of claim 7, wherein said mount section positioned to create a space between the billboard panel and the display sheet.

12. The border trim assembly of claim 8, further comprises a mount plate connected to said mount section, said mount plate, configured to elevate said display sheet tension system.

13. The border trim assembly of claim 12, wherein said mount plate positioned to create a space between the billboard panel and the display sheet.

14. The border trim assembly of claim 3, said attachment mechanism configured to secure the display sheet tension system.

15. The border trim assembly of claim 1, wherein said support section connected to said mount section configured to elevate said concave member.

16. The border trim assembly of claim 15, wherein said support section configured to receive an attachment mechanism.

17. The border trim assembly of claim 16, wherein said attachment mechanism configured to secure a latch mechanism.

18. The border trim assembly of claim 1, wherein said support section further comprises a first spring mount.

19. The border trim assembly of claim 18, wherein said trim cap further comprises a second spring mount.

20. The border trim assembly of claim 19, further comprising a spring positioned between said first spring mount and said second spring mount, wherein said spring configured to rotate said trim cap about said concave member.

21. The border trim assembly of claim 1, wherein one or more of said mount section, said hanger section, said support section, and said trim cap positioned in separate planes.

22. The border trim assembly of claim 1, wherein one or more of said mount section, said hanger section, said support section, and said trim cap configured to connect one section to another section.

23. The border trim assembly of claim 22, wherein one or more of said mount section, said hanger section, said support section, and said trim cap configured with reinforced connections from one section to another section.

24. The border trim assembly of claim 1, wherein said trim cap further comprises a pin member configured to releasably rotate within said concave member.

25. The border trim assembly of claim 24, wherein said trim cap further comprises a first extension configured to extend said pin member to said concave member.

26. The border trim assembly of claim 19, wherein said trim cap further comprises a second extension configured to extend said second spring mount.

27. The border trim assembly of claim 1, wherein said trim cap further comprises a display contact end configured to be in contact with the display sheet.

28. The border trim assembly of claim 14, wherein said contact extension further comprises a handle configured to grip said contact extension to disengage said contact extension from said display sheet.

29. The border trim assembly of claim 1, wherein said trim cap further comprises one or more extensions positioned in separate planes.

30. The border trim assembly of claim 2, wherein said hanger section further comprises a baffle configured to tension the display sheet.

31. The border trim assembly of claim 1, wherein said trim cap further comprises a cap lock and said support section further comprises a latch configured to lock said trim cap to said support section in a closed position.

32. A border trim assembly for a billboard having an exposed display sheet tension system for attachment of a display sheet to the billboard panel, the assembly comprising:
a structure having a mount section configured to position the display sheet tension system, a hanger section configured to affix said structure to the billboard panel, and a support section;
a concave member positioned on said support section;
a trim cap configured to rotate about said concave member, wherein said trim cap configured to cover the display sheet tension system; and
a spring positioned between said support section and said trim cap wherein said spring is configured to rotate said trim cap about said concave member.

33. A method of covering an exposed display sheet tension system for attachment of a display sheet to the billboard panel comprising the steps of:
providing a structure having a mount section configured to position the display sheet tension system, a hanger section configured to affix said structure to the billboard panel, and a support section, a concave member positioned on said support section, and a trim cap configured to rotate about said concave member, wherein said trim cap configured to cover the display sheet tension system;
mounting said border trim assembly to the billboard frame;
adjusting said trim cap to fit the gap between the display sheet and said support section; and
positioning a leaf spring between said support section and said trim cap wherein said spring configured to rotate said trim cap about said concave member to cover the display sheet tension system.
